(19) United States
(12) Patent Application Publication
(10) Pub. No.: US 2026/0119238 A1
(43) Pub. Date: Apr. 30, 2026

(54) CONFIGURING AN IT MONITORING SYSTEM

(71) Applicant: The PNC Financial Services Group, Inc., Pittsburgh, PA (US)

(72) Inventor: Jason L. Miller, Chandler, AZ (US)

(21) Appl. No.: 19/322,184

(22) Filed: Sep. 8, 2025

Related U.S. Application Data
(60) Provisional application No. 63/712,086, filed on Oct. 25, 2024.

(51) Int. Cl. G06F 9/48; G06F 16/23; G06F 16/25

(52) U.S. Cl. CPC G06F 9/4881; G06F 16/2343; G06F 16/254; G06F 2209/486

(57) ABSTRACT

Computer-based systems and methods monitor an organization's IT infrastructure. Each of multiple servers has multiple engines for performing multiple jobs, where each engine performs a single instance of a job at a time. Each server prohibits more than one engine from performing the same instance of a job at the same time. Each job is be performed periodically according to a period specific to the job. A schedule for each of the servers is based on the number of servers, the number of engines on each server, and scheduling parameters for each of the plurality of jobs. A database, in communication with the plurality of servers, stores data, including timestamps, from performance of the jobs by the engines. A reporting service(s) in reports performance statistics for the jobs based on the data stored in the database.

### PRIORITY CLAIM

The present application claims priority under 35 U.S.C. § 119(e) to U.S. provisional application Ser. No. 63/712,086, filed Oct. 25, 2024, titled “Configuring an IT Monitoring System,” which is incorporated herein by reference.

### BACKGROUND

Organizations rely heavily on their IT infrastructure to ensure the continuous and efficient operation of business activities. To maintain the performance, security, and availability of such IT systems, it is essential to monitor various components, including servers, networks, databases, and applications. Continuous monitoring helps identify issues such as system failures, security breaches, performance bottlenecks, and unauthorized access in real time. However, constant monitoring of all IT components can be resource-intensive and costly.

Traditionally, IT monitoring systems require manual configuration of schedules, which dictates when and how frequently different aspects of the system are monitored. These schedules are typically based on predefined policies or standard operating procedures, often leading to inefficiencies due to over-monitoring of less critical components and under-monitoring of crucial ones. Moreover, manually configuring these schedules can be time-consuming, prone to human error, and lacks the flexibility to dynamically adapt to changing system needs or operational priorities.

Existing solutions for configuring monitoring schedules generally do not provide robust mechanisms for automating this process or optimizing it based on real-time system performance metrics or evolving business requirements. As a result, organizations face difficulties in balancing the trade-off between maintaining a high level of system vigilance and minimizing the computational and operational overhead associated with continuous monitoring.

### SUMMARY

In one general aspect, the present invention is directed to computer-based systems and methods for monitoring an organization's IT infrastructure. In various embodiments, the system comprises a plurality of servers, each server having a plurality of engines for performing a plurality of jobs, where each engine is configured to perform only a single instance of a job at a time. Also, each server is configured to prohibit more than one engine of the server from performing the same instance of a job at the same time. Also, each job is be performed periodically according to a period specific to the job. The system also comprises a task scheduling server that generates a schedule for each of the servers based on the number of servers, the number of engines on each server, and scheduling parameters for each of the plurality of jobs. The task scheduling server can generate the schedules such that the jobs are distributed across the servers so that no server is scheduled to perform the same instance of a job as another server at the same time. The system also comprises a database in communication with the plurality of servers, where the database is for storing data, including timestamps, from performance of the jobs by the engines of the servers. The system also comprises one or more reporting services in communication with the database, where the reporting service(s) are for reporting performance statistics for the jobs based on the data stored in the database.

Such a system can compare the times it takes to perform the jobs to determine if performance requirements are being met by the IT infrastructure. Further, by distributing the jobs across the servers in such a manner, if one of the servers goes down, the other servers can still perform their scheduled jobs, so the monitoring process can continue without the inoperative server. These and other benefits that can be realized through embodiments of the present invention will be apparent from the description that follows.

### FIGURES

Various embodiments of the present invention are herein by way of example in connection with the following figures.

FIG. 1 is a diagram of a task status reporting system according to various embodiments of the present invention.

FIG. 2 is a timing diagram illustrating how instances of jobs can be allocated to different servers at different time to distribute instances of the jobs across the various servers of the system of FIG. 1 according to various embodiments of the present invention.

FIG. 3 illustrates an example report that can be generated by a reporting service of the system of FIG. 1 according to various embodiments of the present invention.

### DESCRIPTION

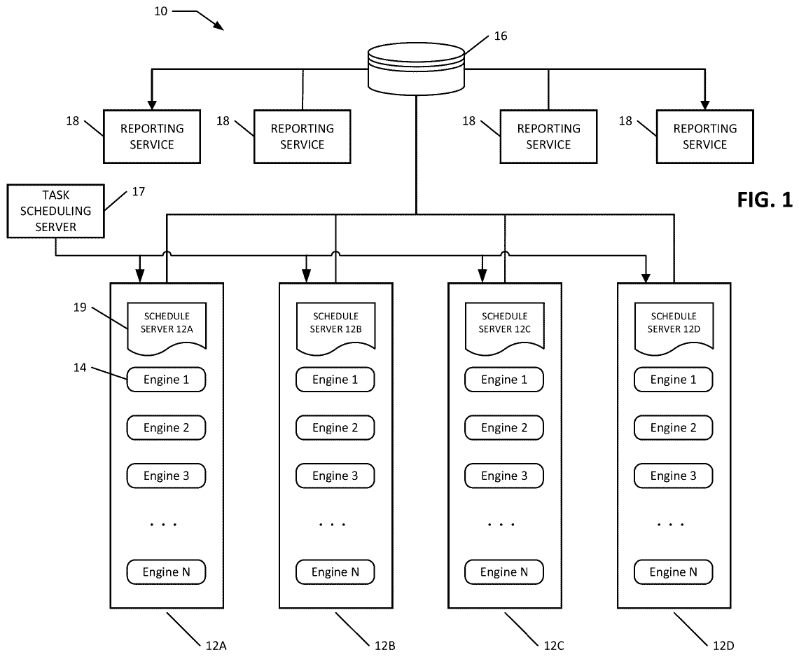

FIG. 1 is a diagram of a task status reporting system 10 for an organization's IT system. The example task health reporting system 10 reporting system shown in FIG. 1 includes multiple servers, in this example, four servers 12A-D. Each server 12A-D includes multiple engines 14. Each engine 14 is for performing a job that has one or more sequential steps or tasks. There is a script for each job, such as a Python script or a PowerShell script, for example, and execution of job's script by an engine 14 requires the engine 14 to execute, for example, a job or action with respect to the IT system of the organization, such as performing an API call, collecting files from an IT resource, collecting data from a certain IT resource that satisfy specified criteria, etc. The task status reporting system 10 can monitor how long it takes the engines 14 to perform the jobs to monitor the health of certain aspects of the organization's IT system.

The multiple servers 12A-D could be distributed across multiple data centers, such as two or more data centers. In the illustrated embodiment, the servers 12A-D all contain the same number (N) of engines 14, although in other embodiments, the servers 12A-D do not need have identical numbers of engines 14. Each of the engines 14 is preferably single threaded so that an engine 14 executes one sequence of operations (or thread) at a time. For example, in such a single-thread engine embodiment, each engine 14 handles only one task, request, or connection at any given moment, processing tasks sequentially rather than concurrently.

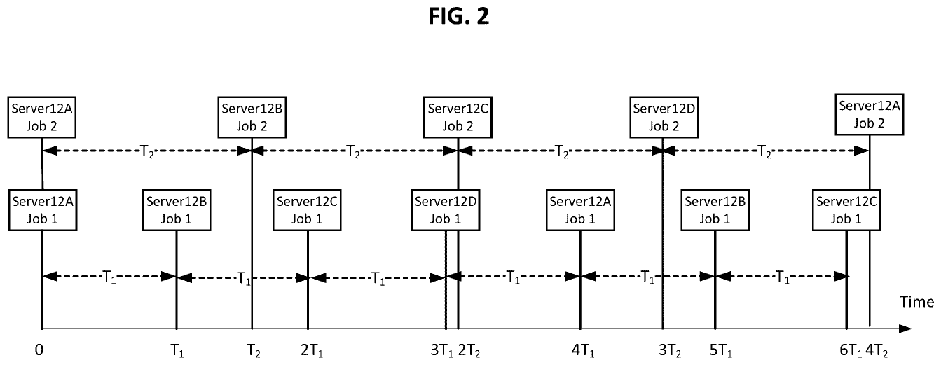

The jobs that the engines 14 are to perform may be on a periodic schedule. And different jobs can have different periods depending on the nature of the job. For example, jobs could be scheduled to run every 5, 10, 20, 60, 240, 720, or 1440 minutes, etc., depending on the nature, sensitivity and/or complexity of the job. Some jobs could even have longer or different periods, such as several days. Preferably, only one engine 14 runs a particular job at a particular scheduled time. For example, with reference to the example shown in FIG. 2, assume a particular job (Job 1) is to be run every T₁=5 minutes. An engine 14 on the server 12A can run the job at Time 0 minutes; an engine 14 on the server 12B can run the job at Time T₁=+5 minutes; an engine 14 on the server 12C can run the job at Time 2T₁=+10 minutes; an engine 14 on the server 12D can run the job at Time 3T₁=+15 minutes; going back to an engine 14 on Server 12A to run the job at Time 4T₁=+20 minutes, and so on. That way, if one of the servers 12A-D becomes non-operational at some point, only its jobs are missed running the downtime and engines 14 on the other servers 12 can continue to execute their scheduled jobs at their scheduled times. As another example, if a second job (Job 2) is to be run every T₂=15 minutes, an engine 14 on the server 12A (e.g., a different engine than the engine running Job 1 at time T0) can run the job at Time 0 minutes; an engine 14 on the server 12B can run the job at Time T₂=+15 minutes; an engine 14 on the server 12C can run the job at Time 2T₂=+30 minutes; an engine 14 on the server 12D can run the job at Time 3T₂=+45 minutes; going back to an engine 14 on Server 12A to run the job at Time 4T₂=+60 minutes, and so on. As described above, servers 12 comprise multiple engines 14, so each of the servers 12A-D can have multiple (N) engines 14 running at the same time to perform multiple (N) jobs at the same time, although also as explained above, each engine is preferably single threaded so that the engine cannot execute more than one job at a time, such that a server cannot be scheduled to run more than jobs than it has engines (N) at a time.

A task scheduling server 17 may coordinate and determine the schedules for the servers 12A-D based on parameters for the jobs consumed by the task scheduling server 17 and based on the number of engines 14 on the servers 12A-D. For example, the task scheduling server 17 can receive values for relevant parameters for each job to be performed by the engines 14. The parameters can include, for example, how often the job is to be run (i.e., its period), how long the job is expected to take for an engine 14 to perform, a spread quantifiers (e.g., standard deviation or variance) on the time needed for the job, a no-earlier-than time to start the job on a given day (e.g., 8:00 am), a no-later-than time to start a job on a given day (e.g., 10:00 pm), etc. Based on the parameter values of the various jobs and other factors, such as the number of engines 14 on the servers 12A-D, the task scheduling server 17 computes and distributes a schedule 19 for each of the servers 12A-D. The servers'schedules are ordinarily different because, as described above, they preferably are not scheduled to perform the same jobs at the same time. That is, if there are M servers, and a job is to be performed every T minutes, each server can be scheduled to perform the job every M×T minutes, and each server's schedule for the job can offset by a L×T minutes from the other servers, where L=1, . . . , (M−1). Using the example above, if there are M=4 servers, with a job to be performed every 5 minutes, each server could perform the job every 4×5=20 minutes, with each server's schedule offset by 5, 10 or 15 minutes from the other servers.

The task scheduling server 17 may consume the parameter values for the jobs in the form of spreadsheets, for example, which the task scheduling server 17 can process to generate the schedules 19. The spreadsheets may specify the parameter values for the jobs, such as, as described above, how often the job is to be run (i.e., its period), how long the job is expected to take for an engine 14 to perform, a spread quantifiers on the time needed for the job, a no-earlier-than time to start the job on a given day, a no-later-than time to start a job on a given day, etc. The task scheduling server 17 may use, for example, Python, Node.js or Java libraries to parse the spreadsheets, which parsing can include extracting the relevant data into a structured format such as an array. The task scheduling server 17 may employ, for example, a constraint based scheduling algorithm, such as Constraint Satisfaction Problems (CSP) or a custom built algorithm, to handle the complex constraints.

As mentioned herein, the engines 14 are preferably single-threaded engines, meaning that they can only perform one job at a time. As soon as an engine 14 completes a job, it can commence the next available job in the schedule 19 for the engine's server 12A-D. As such, each job could have a status of “AutoJobStart,” “Finished Normal,” or “Job Error,” for example. The task scheduling server 17 may recompute the schedules 19 for the servers 12A-D as often as necessary. For example, if a server 12 goes down, the task scheduling server 17 may recompute the schedules for the remaining servers, and then recompute the schedules again when the previously down server comes back up. As mentioned, while a server, say server 12B in FIG. 1, is down and before the revised schedules are computed, the jobs for server 12B can be skipped but the other servers 12A, C, D can continue according to their respective, current schedules 19.

As shown in FIG. 1, the system 10 may comprise a database 16, which may be implemented, for example, in various embodiments, as a SQL server database. The database 16 may store data from the engines'performance of their jobs so that performance data may be reported by one or more reporting services 18. That is, each engine 14 may write data to the database 16 about its job, including timestamps for completion of each task/step in the job and a timestamp for completion of the job as a whole. The reporting service(s) 18 may be implemented, for example, with a SQL Server Reporting Service(s) (SSRS), which is a based report generation software system for creating, managing, and/or delivering reports, including interactive, tabular, graphical, and free-form reports, from data stored in the database 16. The reporting services 18 can run on servers that are connected to the database 16 via an electronic data network, such as a LAN, WAN, could network, intranet, etc. In that connection, the servers 12A-D may also be connected to the database 16 via such an electronic data network, And the servers 12A-D may be connected to the IT resources that the engines 14 interface with via such an electronic data network.

To that end, the engines 14 can be ETL engines (Extract, Transform, Load engines), which can move data from various sources (e.g., files in an organization's network) into a destination (e.g., database 16). The engines 14 can retrieves or extracts raw data from different sources, such as databases, applications, APIs, or files. These sources can be structured (e.g., SQL databases), semi-structured (e.g., XML or JSON files), or unstructured (e.g., plain text), for example. The engines can process the extracted data to meet the format and requirements of the database 16. This step can involve filtering, cleaning (removing duplicates, correcting errors), aggregating, joining data from multiple sources, converting data types, and applying business rules or logic, for example. After transformation, the processed data can be loaded into the database 16, where it can be used for reporting, analytics, and other business processes, as described herein.

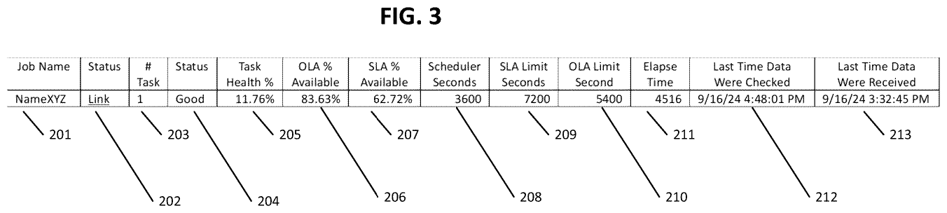

FIG. 3 is an example of a table that could be generated by the reporting services 18 based on data from the engines 14 stored in the database 16. The first column 201 lists the names of the jobs performed by the engines 14. For simplicity, only one job (NameXYZ) is listed in FIG. 3. The second column 202 can provide a hyperlink that a user can click on to see more data about the job, such as data about each step in the job, etc. The third column 203 lists the number of tasks in the job. The illustrated example shows that the NameXYZ job has only 1 task, although as described herein other jobs could have more than one task/step. Another column 204 can provide a textual status description (e.g., “good” or “error”) for the job and can be computed based on whether the last time the job ran exceeded (or not) a specified time for the job (e.g., a specified operating level agreement (OLA) time). Another column 205 reports the task health for the job. The task health can be a percentage value ranging from 0.00% to 100.00%, for example. For example, if the job runs within the OLA time limit, it achieves a perfect health score of 100%. If it exceeds the OLA limit, the health score can decrease proportionally to how much it overruns the max allowed time.

Another column 206 can report the operating level agreement (OLA) percentage available and column 207 can report the service level agreement (SLA) percentage available for the job. The computations for these values are described below. The column 208 can show how frequently the job is to be scheduled to run (i.e., its period). The columns 209 and 210 can show the SLA and OLA limits, in time, respectively for the job. A designer of the jobs, familiar with aspects of the organization's IT resources and requirements, can specify these values based on the nature of the job, including the demands of the customer, which can be another part of the organization. The column 211 can show how long (in seconds) since the last time this job was completed. A timestamp for the last time the job was completed can be shown in column 213, with the timestamp for the last time data for this job in the database 216 was checked being shown in the column 212. Thus, the time difference between columns 212 and 213 can be the elapsed time for column 211.

The OLA % available at column 206 can be computed by dividing the elapsed time for the job (column 211) by the OLA limit (column 210). The SLA % available at column 207 can be computed by dividing the elapsed time for the job (column 211) by the SLA limit (column 209). Of course, in other embodiments, the tables could have additional or fewer columns of data. Also, color coding and/or bar graphs could be used to show the OLA and/or SLA % available, for example.

As mentioned above, the jobs performed by the engines 14 can have one or more tasks/steps. When an engine 14 completes a job, it can report data from the job to the database 16, and the timestamp for when the data were received can be recorded by the database 16 and used for column 213 by the reporting service(s) 18 as described above. The timestamp for column 212 can be the time that the data for a report were checked, such as by a reporting service 18.

The reports generated by the reporting service(s) 18 may be sortable, such as by a particular job, by a particular category of job, by a particular server, by jobs that have OLA and/or SLA % available values in certain ranges or buckets, etc., and combinations of these search criteria.

Each server 12A-D preferably comprises one or more processors for executing the engines 14, along with memory and storage for storing the scripts that are executed by the engines 14. Each of the processors may comprise multiple cores, such as 8, 16 or 20 processor cores, for example. In some embodiments, each server may comprise as many processor cores as there are engines to help ensure that each engine can run without contention. However, this is not a requirement. The engines can be scheduled on fewer cores using conventional OS-level time-sharing and context switching. That is, a server may execute more engines than it has processor cores, and the single-threaded nature of the engines ensures that each engine performs one job at a time, regardless of how processor time is allocated.

The servers'computer memories (e.g., RAM) can store the scripts and the data that the engines 14 operate on during execution. When a script is loaded and run, the data it processes (like variables, datasets, or objects) can be held in RAM. If multiple scripts or processes run concurrently, each can have its own portion of memory. The scripts, along with any libraries and dependencies, can be stored on the servers'hard drive or SSD. Such storage can also used to maintain logs, databases, or other persistent data that the engines 14 might access or generate.

The servers 12A-D could be parts of on-premises networks of the organization and/or cloud networks. The servers 12A-D can be containerized servers or non-containerized (e.g., bare-metal or traditional) servers. A containerized server is essentially a virtualized environment that packages an application and its dependencies together into a single unit, known as a container. This container can be run on any system that supports the containerization technology (e.g., Docker, Kubernetes). Non-containerized servers are physical machines that run a complete operating system and all necessary applications.

As mentioned previously, each engine 14 is preferably single-threaded so that an engine 14 can also perform only one job at a time. Also, each server 12 preferably prevents multiple engines 14 from performing the same job simultaneously. For example, when a server 12 allocates a job to a particular engine 14, the script for the job can cause the engine 14 to generate a locking file that locks other engines 14 on the server 12 from executing the script for the job so that there is only one instance of the job on the server 12 at a particular time. As used herein, an “instance”of a job refers to a particular scheduled (or periodic) execution of the particular job. The task scheduling server 17 distributes job instances across the servers so that no two servers are scheduled to perform the same instance of a job at the same scheduled time.

When an engine 14 starts to execute a job, it can first check whether a locking file already exists for the job. If the file exists, this usually indicates that another instance of the process is already working on that job, so the new process will not proceed. If no locking file is found, the engine 14 creates one, signaling to the other engines 14 that it is handling the task. The locking file may contain information such as the process ID (PID), timestamp, or host name, to further help track which instance of the process has the lock. The file is typically created with exclusive access privileges, meaning that only one process can create or modify the file at a time. Other processes attempting to create the same locking file will fail. Once the task is completed, the process deletes the locking file, indicating that the resource is free for other processes to use.

If an instance of a process encounters technical issues but leaves a locking file in place, this can cause problems, as other instances or jobs might be indefinitely blocked, waiting for the lock to be released. To handle such situations, the servers 12A-D may employ one or more mechanisms to override or remove the stale locking file, such as timeout-based lock expiration or overriding the locking file if the locking file is accessed by other engines 14 more than a threshold number of times (note that the threshold could be different for different jobs, e.g., longer jobs might have a greater threshold).

In some embodiments, the task scheduling server 17 may be further configured to perform dynamic workload balancing across the servers 12A-12D based on real-time or recent resource utilization metrics. For example, the task scheduling server 17 can collect or receive telemetry data from each server 12 regarding processor utilization, memory usage, disk I/O, network bandwidth, or other performance indicators. Based on these workload metrics, the task scheduling server 17 can adjust job assignments to avoid overloading servers that are already near capacity. In this manner, when generating or updating the schedules 19, the task scheduling server 17 may favor assigning new job instances to servers exhibiting lower current or average load levels, thereby balancing the execution of jobs across the available infrastructure. Such load-aware scheduling may be used in conjunction with, or as an alternative to, static schedule generation based solely on job parameters and engine availability. The task scheduling server 17 may periodically reevaluate server workloads and reoptimize job distributions accordingly to maintain performance and avoid bottlenecks.

In various embodiments, a process according to embodiments of the present invention can involve the task scheduling server 17 generating, and distributing, respective, individualized schedules 19 for the servers 12. The scheduling depends on the number (M) of servers 12, the number (N) of engines 14 on each server 12 (as a single-threaded engine can only perform one job at a time), and timing parameters for the jobs, such as their periods, no-earlier and no-later than start times, etc., as described herein. Then the engines 14 of each server 12 can perform the jobs of that server one after another according to the server's schedule 19, with each engine 14 picking up a new job as soon as it completes a job, with each engine 14 performing only one job at a time, and no engines on the server performing the same job at the same time, for example.

The scale of the system 10 could be on the order of four servers, with forty one engines each, thus totaling 164 engines, running more than 60,000 jobs daily. The engines 14 write data about their jobs, including timestamps, to the database 16. Then the reporting services 18 can generate reports about the performance of the jobs so that a viewer or user of the reports can assess the status of aspects of an organization's IT infrastructure.

In some embodiments, the system 10 may be further configured to perform real-time alerting or anomaly detection based on the performance data generated by the engines 14 and stored in the database 16. For example, the reporting services 18, or a dedicated alerting module in communication with the database 16, may monitor job execution results to identify conditions that deviate from expected operational baselines. Such conditions can include jobs exceeding specified SLA or OLA thresholds, jobs failing to complete within a specified time window, or missing job executions altogether. In response to detecting such anomalies, the system may automatically generate and transmit electronic alerts to designated recipients via email, messaging systems, dashboards, or API endpoints. Alerts may be prioritized or categorized based on severity, frequency of occurrence, or impact on system operations. The system may also maintain an audit trail of such alerts, which can be stored in the database 16 and included in historical reports generated by the reporting services 18. In some embodiments, anomaly detection may be enhanced using statistical techniques or rule-based thresholds that are configurable per job, job type, or resource category.

The engines 14 can be implemented as sets of instructions that run on the servers'hardware to execute the scripts for the jobs. The software for the engines 14 may use any suitable computer programming language such as Java, Python, PowerShell, Ruby, C #, or C++, for example, using conventional, functional, or object-oriented techniques. Programming languages for computer software and other computer-implemented instructions may be translated into machine language by a compiler or an assembler before execution and/or may be translated directly at run time by an interpreter.

In one general aspect, therefore, the present invention is directed to a task monitoring system comprising a plurality of servers, a task scheduling server in communication with the plurality of servers, a database in communication with the plurality of servers, and one or more reporting services. Each server has a plurality of engines for performing a plurality of jobs, wherein each engine is configured to perform only a single instance of a job at a time, wherein each server is configured to prohibit more than one engine of the server from performing the same instance of a job at the same time, and wherein each job is to be performed periodically according to a period specific to the job. The task scheduling server is for generating a respective schedule for each of the servers based on a quantity of the plurality of servers, a quantity of engines on each server, and scheduling parameters for each of the plurality of jobs, wherein the task scheduling server is for generating the schedules for the servers such that the jobs are distributed across the servers so that no server is scheduled to perform the same instance of a job as another server at the same scheduled time. The database is for storing data, including timestamps, from performance of the jobs by the engines. Each reporting service is implemented by one or more processors executing software stored in memory, the one or more reporting services being in communication with the database, and wherein the one or more reporting services are configured to digitally report performance statistics for the jobs based on the data stored in the database.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A task monitoring system comprising:
a plurality of servers, each server having a plurality of engines for performing a plurality of jobs, wherein each engine is configured to perform only a single instance of a job at a time, wherein each server is configured to prohibit more than one engine of the server from performing the same instance of a job at the same time, and wherein each job is to be performed periodically according to a period specific to the job;
a task scheduling server in communication with the plurality of servers, wherein the task scheduling server is for generating a respective schedule for each of the servers based on a quantity of the plurality of servers, a quantity of engines on each server, and scheduling parameters for each of the plurality of jobs, wherein the task scheduling server is for generating the schedules for the servers such that the jobs are distributed across the servers so that no server is scheduled to perform the same instance of a job as another server at the same scheduled time;
a database in communication with the plurality of servers, wherein the database is for storing data, including timestamps, from performance of the jobs by the engines; and
one or more reporting services, each implemented by one or more processors executing software stored in memory, the one or more reporting services being in communication with the database, and wherein the one or more reporting services are configured to digitally report performance statistics for the jobs based on the data stored in the database.

2. The system of claim 1, wherein each of the plurality of engines is single-threaded and configured to perform only one job at a time.

3. The system of claim 1, wherein each server is configured to prevent multiple engines of the server from performing the same job at the same time by using a lock file mechanism associated with the job.

4. The system of claim 3, wherein a stale lock file is overridden based on a threshold number of access attempts or a timeout period.

5. The system of claim 1, wherein the task scheduling server is configured to generate the schedules using a constraint-based scheduling algorithm that considers job timing constraints and engine availability.

6. The system of claim 1, wherein the schedules are generated such that no two servers are scheduled to execute the same instance of a job at the same scheduled time.

7. The system of claim 1, wherein the task scheduling server is further configured to recompute the schedules in response to detection of a server failure.

8. The system of claim 1, wherein one or more of the engines is configured to perform extract, transform, and load (ETL) operations on data obtained from an IT resource.

9. The system of claim 1, wherein the scheduling parameters for the jobs are obtained by the task scheduling server from a spreadsheet specifying values for at least a job period, earliest start time, or expected execution time.

10. The system of claim 1, wherein the scheduling parameters for each job comprise one or more of: a period, an expected execution duration, a no-earlier-than start time, or a no-later-than start time.

11. The system of claim 1, wherein the one or more reporting services are configured to compute and report one or more of: a service level agreement (SLA) percentage available, an operating level agreement (OLA) percentage available, or a task health score.

12. The system of claim 1, wherein the one or more reporting services are configured to generate a digital report comprising a table including values for job name, task health, SLA and OLA limits, elapsed time, and last execution timestamps.

13. The system of claim 1, wherein the schedules are generated such that each server is assigned to execute a given job every M×T minutes, where M is the quantity of servers and T is the period of the job.

14. The system of claim 1, wherein the one or more reporting services comprise one or more SQL Server Reporting Services (SSRS) instances configured to retrieve job performance data from the database and generate reports.

15. A computer-implemented method for monitoring an information technology (IT) infrastructure, the method comprising:
generating, by a task scheduling server, a respective schedule for each of a plurality of servers based on a quantity of the plurality of servers, a quantity of engines on each server, and scheduling parameters for a plurality of jobs to be executed periodically, wherein the schedules are generated such that no server is scheduled to perform the same instance of a job as another server at the same scheduled time;
executing, by engines on the plurality of servers, the plurality of jobs according to the respective schedule for each server, wherein each engine is configured to perform only one job at a time, and wherein each server prevents more than one of its engines from executing the same job at the same time;
storing, in a database in communication with the plurality of servers, data from execution of the jobs, including timestamps associated with execution of the jobs by the engines; and
digitally reporting, by one or more reporting services implemented by one or more processors executing software stored in memory, performance statistics for the jobs based on the data stored in the database.

16. The method of claim 15, wherein each engine is single-threaded and configured to perform only one job at a time.

17. The method of claim 16, further comprising, for each engine executing a job, creating a lock file associated with the job to prevent other engines on the same server from executing the same job at the same time.

18. The method of claim 17, further comprising overriding a stale lock file based on a timeout period or based on a threshold number of unsuccessful access attempts to the lock file.

19. The method of claim 18, wherein generating the respective schedule for each server comprises applying a constraint-based scheduling algorithm that accounts for the scheduling parameters and availability of engines on the plurality of servers.

20. The method of claim 19, further comprising detecting a failure of one of the servers and, in response, recomputing respective schedules for remaining servers.
